(19) United States
(12) Patent Application Publication
(10) Pub. No.: US 2009/0262249 A1
(43) Pub. Date: Oct. 22, 2009

(54) Interpolated frame generating method

(75) Inventors: Sheng-Chun Niu, Tainan County (TW); Ling-Hsiu Huang, Tainan County (TW)

Correspondence Address: RABIN & Berdo, PC, 1101 14TH STREET, NW, SUITE 500, WASHINGTON, DC, 20005, US

(73) Assignee: Himax Media Solutions, Inc., Tainan County (TW)

(21) Appl. No.: 12/081,848

(22) Filed: Apr. 22, 2008

(51) Int. Cl. H04N 5/14

(52) U.S. Cl. 348/699; 348/E05.062

(57) ABSTRACT

An interpolated frame generating method is provided. The interpolated frame generating method comprises the steps of: providing a first frame and a second frame; calculating a first motion vector having a first x-component with a first x-length along the x-axis and a y-component with a first y-length along the y-axis; determining the first x-length and the y-length is an odd integral number of pixels; generating a second motion vector comprising: a second x-component with a second x-length smaller than the first x-length and a second y-component with a second y-length smaller than the first y-length, wherein the second x-length and the second y-length are an integral number of pixels respectively; the direction of the second x-component and y-component is the same as the first x-component and y-component respectively; and generating an interpolated frame between the first and the second frame according to the first frame and the second motion vector.

### BACKGROUND

1. Field of Invention

The present invention relates to a frame generating method. More particularly, the present invention relates to an interpolated frame generating method.

2. Description of Related Art

The convergence between broadcasting, telecommunication, and Internet has created a proliferation of the number of video formats and increased the need for high quality frame rate conversions. Frame rate represents the number of frames (images) per second of a video or film material. For example, 35 mm film has a frame rate of 24 frames per second (fps), television has a frame rate of 30 fps in North America and 25 fps in Europe, while computer monitors work at 60, 75, or even higher frame rates. With the convergence, users require that a single display device be able to display high quality video at various frame rates coming from different sources.

When a video processing tool performs a frame rate up conversion, interpolated frames need to be produced among the original frames. The conventional frame rate up conversion algorithm generates an interpolated frame by calculating a motion vector between the two frames and interpolating a new frame (the interpolated frame) with the half of the motion vector between the two frames. But when the length of the motion vector is an odd number of pixels, the length of the half of the motion vector can't be an integral number of pixels. The interpolated frame generated by the method mentioned won't be correct since the motion vector with a length of non-integral number of pixels is not allowed.

Accordingly, what is needed is an interpolated frame generating method to generate an interpolated frame between two frames with a motion vector having a length of integral number of pixels to overcome the above issues. The present invention addresses such a need.

### SUMMARY

An interpolated frame generating method is provided. The interpolated frame generating method comprises the steps of: providing a first frame and a second frame; calculating a first motion vector from the first frame to the second frame, wherein the first motion vector has a first x-component with a first x-length along the x-axis and a y-component with a first y-length along the y-axis; determining at least one of the first x-length and the y-length is an odd integral number of pixels; generating a second motion vector comprising: a second x-component with a second x-length smaller than the first x-length, wherein the second x-length is an integral number of pixels; the direction of the second x-component is the same as the first x-component; and a second y-component with a second y-length smaller than the first y-length, wherein the second y-length is an integral number of pixels; the direction of the second y-component is the same as the first y-component; and generating an interpolated frame between the first and the second frame according to the first frame and the second motion vector.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a flow chart of the first embodiment of the interpolated frame generating method of the present invention;

FIG. 2A is a diagram of an object moving from a first position in a first frame to a second position in a second frame;

FIG. 2B is a diagram of the object of the interpolated frame after performing the interpolated frame generating method of the present invention;

FIG. 3A is a diagram of a diagram of the first frame, the interpolated frame and the second frame after performing the symmetric motion vector method;

FIG. 3B is a diagram of the first frame, the interpolated frame and the second frame after performing the interpolated frame generating method of the present invention;

FIG. 3C is another diagram of the first frame, the interpolated frame and the second frame after performing the interpolated frame generating method of the present invention;

FIG. 4A is a 3D view of the first frame, the interpolated frame and the second frame after performing the symmetric motion vector method;

FIG. 4B is a 3D view of the first frame, the interpolated frame and the second frame after performing the interpolated frame generating method of the present invention; and

FIG. 4C is another 3D view of the first frame, the interpolated frame and the second frame after performing the interpolated frame generating method of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

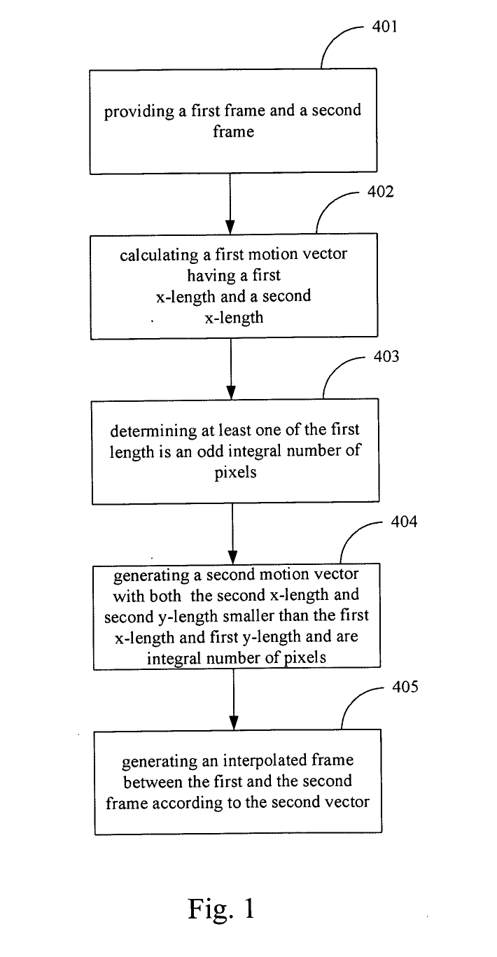

FIG. 1 is a flow chart of the first embodiment of the interpolated frame generating method of the present invention. In step 401, a first frame and a second frame are provided; in step 402, a first motion vector from the first frame to the second frame is calculated, wherein the first motion vector has a first x-component with a first x-length along the x-axis and a y-component with a first y-length along the y-axis. In the present embodiment, the first motion vector is calculated through a motion estimation process.

Then in step 403, determining at least one of the first x-length and the y-length is an odd integral number of pixels. In step 404, generating a second motion vector comprising: a second x-component with a second x-length smaller than the first x-length, wherein the second x-length is an integral number of pixels; the direction of the second x-component is the same as the first x-component; and a second y-component with a second y-length smaller than the first y-length, wherein the second y-length is an integral number of pixels; the direction of the second y-component is the same as the first y-component. In the present embodiment, the process to generate the second x-component depends on different conditions. When the first x-length is an even integral number of pixels, the second x-length is the half of the first x-length; But when the first x-length is an odd integral number of pixels, the second x-length can be generated by (1) adding a half-pixel to the half of the first x-length or (2) subtracting a half-pixel from the half of the first x-length. As to the second y-component, the generation process is the same as the second x-component. The in final steps 405, an interpolated frame between the first and the second frame is generated according to the first frame and the second motion vector.

Thus, if both of the first x-length and the first y-length are even integral number of pixels, the motion vector from the first frame to the interpolated frame and the motion vector from the interpolated frame to the second frame are symmetric. If at least one of the first x-length and the first y-length is an odd integral number of pixels, the interpolated frame generated by the interpolated frame generating method of the present invention will make the motion vector from the first frame to the interpolated frame and the motion vector from the interpolated frame to the second frame asymmetric. Through the interpolated frame generating method of the present invention, the x-length and y-length of the motion vector between the interpolated frame and the first frame or between the interpolated frame and the second frame won't be a length of non-integral number of pixels.

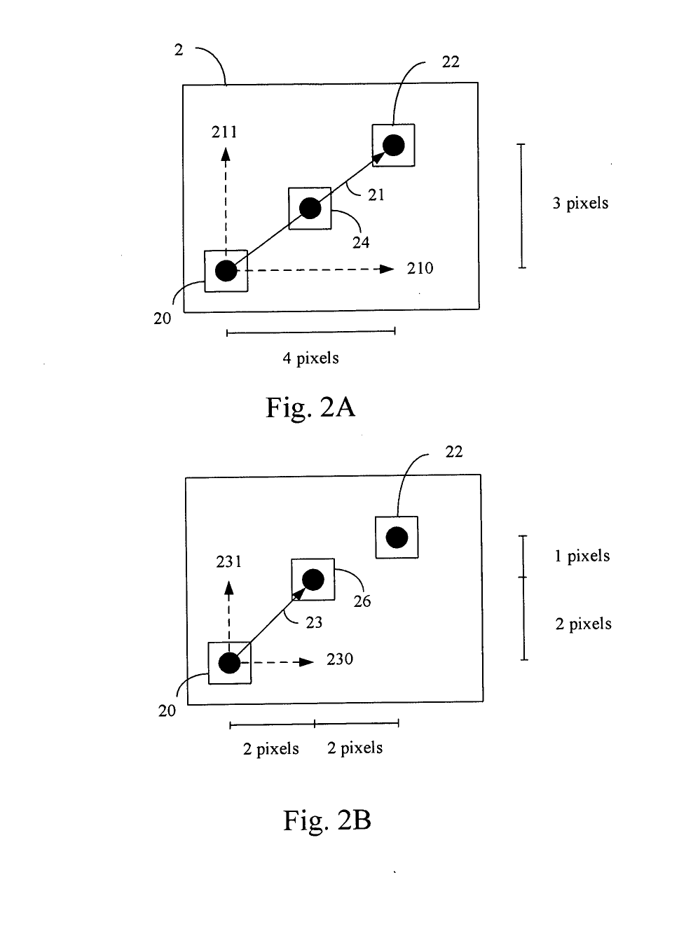

FIG. 2A shows an object moving from a first position 20 to a second position 22. The first position 20 is substantially in a first frame and the second position 22 is substantially in a second frame. But in FIG. 2A the first frame and the second frame are superimposed, therefore only one frame 2 is shown. The first motion vector 21 from the first frame to the second frame has a first x-component 210 with a first x-length of 4 pixels along the x-axis and a y-component 211 with a first y-length of 3 pixels along the y-axis. If a symmetric motion vector method is used to generate an interpolated frame, the object in the interpolated frame will move to position 24 as depicted in FIG. 2A, and the second y-length will be 1.5 pixels. But the non-integral number of pixels is not allowed. FIG. 2B shows the result of the interpolated frame generating method of the present invention. Because the first y-length of the first motion vector 21 is 3 pixels, which is an odd-integral number of pixels, the second y-length of the second y-component 231 is generated by adding a half-pixel to the half of the first y-length. Therefore, the second y-length is, 3/2+0.5=2. In other embodiment, the second y-length can also be generated by subtracting a half-pixel to the half of the first y-length. On the other side, because the first x-length is 4 pixels, which is an even-integral number of pixels, the second x-length of the second x-component 230 is the half of the first x-length. Therefore, the second x-length is 4/2=2. The second motion vector 23 is thus derived from the second x-component 230 and the second y-component 231. The object of the interpolated frame generated according to the second motion vector 23 moves to position 26. The motion vector from the first frame to the interpolated frame and the motion vector from the interpolated frame to the second frame are thus not symmetric.

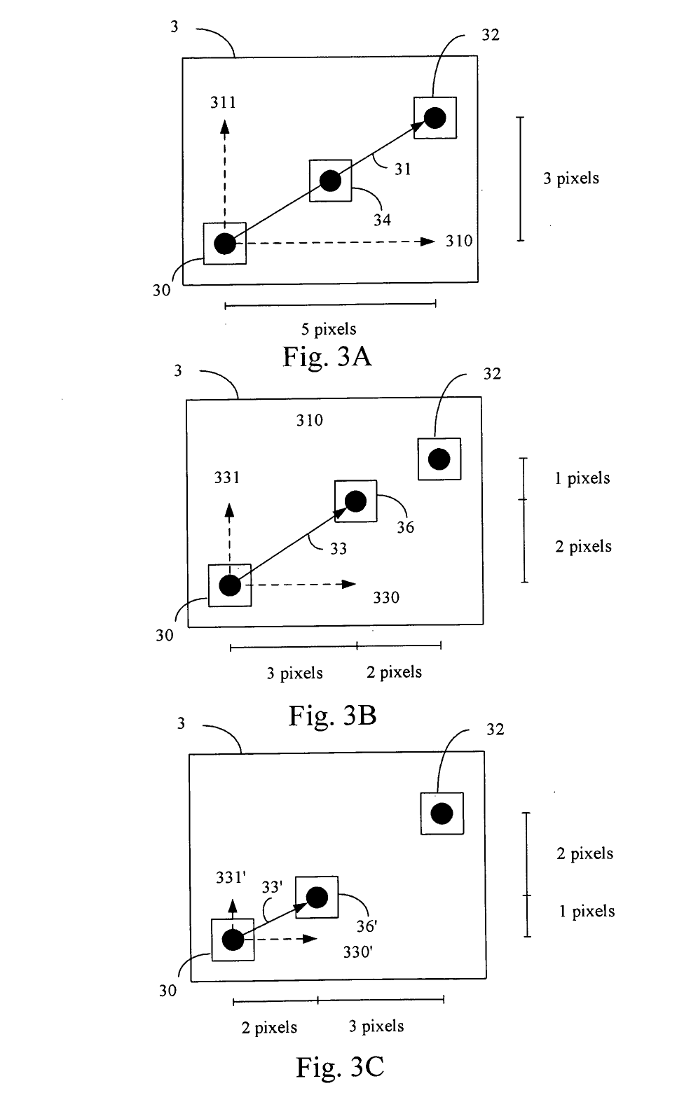

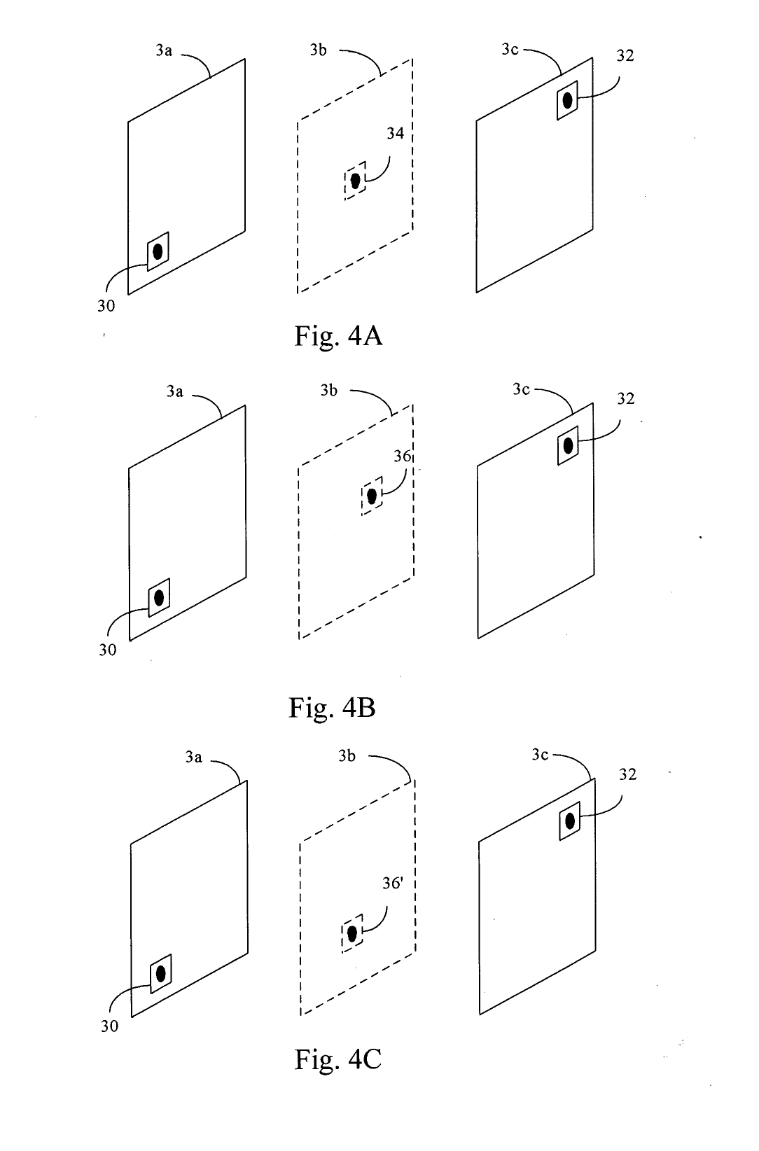

FIG. 3A shows an object moving from a first position 30 to a second position 32. The first position 30 is substantially in a first frame and the second position 32 is substantially in a second frame. But in FIG. 3A the first frame and the second frame are superimposed, therefore only one frame 3 is shown. The first motion vector 31 from the first frame to the second frame has a first x-component 310 with a first x-length of 5 pixels along the x-axis and a y-component 311 with a first y-length of 3 pixels along the y-axis. If a symmetric motion vector method is used to generate an interpolated frame, the object in the interpolated frame will move to position 34 as depicted in FIG. 3A, and the second y-length will be 1.5 pixels and the second x-length will be 2.5 pixels. But the non-integral number of pixels is not allowed. FIG. 4A further illustrates the relation of the first frame 3a, the interpolated frame 3b, and the second frame 3c by a 3D view, wherein the interpolated frame 3b of FIG. 4A is generated by the symmetric motion vector method.

FIG. 3B shows the result of the interpolated frame generating method of the present invention. Because the first y-length of the first motion vector 31 is 3 pixels, which is an odd-integral number of pixels, the second y-length of the second y-component 331 is generated by adding a half-pixel to the half of the first y-length. Therefore, the second y-length is, 3/2+0.5=2. In other embodiment, the second y-length can also be generated by subtracting a half-pixel to the half of the first y-length. On the other side, because the first x-length of the first motion vector 31 is 5 pixels, which is an odd-integral number of pixels, the second x-length of the second x-component 330 is generated by adding a half-pixel to the half of the first x-length. Therefore, the second x-length is, 5/2+0.5=3. In other embodiment, the second x-length can also be generated by subtracting a half-pixel to the half of the first x-length. The second motion vector 33 is thus derived from the second x-component 330 and the second y-component 331. The object of the interpolated frame generated according to the second motion vector 33 moves to position 36. The motion vector from the first frame to the interpolated frame and the motion vector from the interpolated frame to the second frame are thus not symmetric. FIG. 4B further illustrates the relation of the first frame 3a, the interpolated frame 3b, and the second frame 3c by a 3D view, wherein the interpolated frame 3b of FIG. 4B is generated by the interpolated frame generating method of the present invention.

In FIG. 3C shows the second motion vector 33′ derived by a second x-component 330′ and a second y-component 331′, wherein the second x-length of the second x-component 330′ and the second y-length of the second y-component 331′ are generated by subtracting a half-pixel to the half of the first x-length and y-length respectively. Thus, the second x-length becomes 5/2−0.5=2, and the second y-length becomes 3/2−0.5=1. The resulting position of the object of the interpolated frame becomes 36′. FIG. 4C further illustrates the relation of the first frame 3a, the interpolated frame 3b, and the second frame 3c by a 3D view, wherein the interpolated frame 3b of FIG. 4C is generated by the interpolated frame generating method of the present invention.

The interpolated frame generating method of the present invention generates an interpolated frame with integral number of pixels of the x-length and y-length of the motion vector between the interpolated frame and a first frame and the motion vector between the interpolated frame and a second frame.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An interpolated frame generating method comprising the steps of:
providing a first frame and a second frame;
calculating a first motion vector from the first frame to the second frame, wherein the first motion vector has a first x-component with a first x-length along the x-axis and a y-component with a first y-length along the y-axis;
determining at least one of the first x-length and the y-length is an odd integral number of pixels;
generating a second motion vector comprising:
a second x-component with a second x-length smaller than the first x-length, wherein the second x-length is an integral number of pixels; the direction of the second x-component is the same as the first x-component; and
a second y-component with a second y-length smaller than the first y-length, wherein the second y-length is an integral number of pixels;
the direction of the second y-component is the same as the first y-component; and
generating an interpolated frame between the first and the second frame according to the first frame and the second motion vector.

2. The interpolated frame generating method of claim 1, when the first x-length is an odd integral number of pixels, the second x-length is generated by adding a half-pixel to the half of the first x-length.

3. The interpolated frame generating method of claim 1, when the first x-length is an odd integral number of pixels, the second x-length is generated by subtracting a half-pixel from the half of the first x-length.

4. The interpolated frame generating method of claim 1, when the first x-length is an even integral number of pixels, the second x-length is the half of the first x-length.

5. The interpolated frame generating method of claim 1, when the first y-length is an odd integral number of pixels, the second y-length is generated by adding a half-pixel to the half of the first y-length.

6. The interpolated frame generating method of claim 1, when the first y-length is an odd integral number of pixels, the second y-length is generated by subtracting a half-pixel from the half of the first y-length.

7. The interpolated frame generating method of claim 1, when the first y-length is an even integral number of pixels, the second y-length is the half of the first y-length.

8. The generating method of claim 1, wherein the first motion vector is calculated through a motion estimation process.
